(19) United States
(12) Patent Application Publication
(10) Pub. No.: US 2009/0116264 A1
(43) Pub. Date: May 7, 2009

(54) Power supply circuit with voltage converting circuits and control method therefor

(75) Inventor: Ching-Chung Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/291,208

(22) Filed: Nov. 7, 2008

(30) Foreign Application Priority Data
Nov. 7, 2007 (CN) 200710124287.9

(51) Int. Cl. H02M 3/335; H02M 7/00

(52) U.S. Cl. 363/20; 363/125

(57) ABSTRACT

An exemplary power supply circuit (20) includes an input terminal (201), an output terminal (202), voltage converting circuits (23, 24), and a pulse width modulation circuit (22). The input terminal is capable of receiving a direct current voltage. The output terminal is capable of providing voltage to a load circuit. The voltage converting circuits are connected in parallel between the input terminal and the output terminal. The pulse width modulation circuit is configured to control the voltage converting circuits to convert the direct current voltage into pulse voltages. A phase of each pulse voltage is delayed relative to that of an adjacent preceding pulse voltage.

### FIELD OF THE INVENTION

The present disclosure relates to power supply circuits, and more particularly to a power supply circuit having a plurality of voltage converting circuits.

### GENERAL BACKGROUND

Power supply circuits are widely used in modern electronic devices, providing power voltage signals to enable function.

One such power supply circuit generally includes a voltage converting circuit for converting a provided alternating current (AC) voltage to a direct current (DC) voltage. The DC voltage signal is then provided to a load circuit, so as to enable the load circuit to function.

Typically, the voltage converting circuit can only convert the AC voltage into a DC pulse voltage, whereupon the DC pulse voltage must be filtered by a filter circuit. However, the DC pulse voltage has a relatively long low level period. When the power supply circuit is functioning, a phase of the output voltage has a relatively high ripple. That is, the output of the power supply circuit is somewhat unstable.

What is needed is to provide a power supply circuit that can overcome the limitations described.

### SUMMARY

In one exemplary embodiment, a power supply circuit includes an input terminal, an output terminal, a plurality of voltage converting circuits, and a pulse width modulation circuit. The input terminal is capable of receiving a direct current voltage. The output terminal is capable of providing voltage to a load circuit. The plurality of voltage converting circuits are connected in parallel between the input terminal and the output terminal. The pulse width modulation circuit is configured to control the plurality of voltage converting circuits to convert the direct current voltage into a plurality of pulse voltages. A phase of each pulse voltage is delayed relative to that of an adjacent preceding pulse voltage.

Other novel features and advantages will become more apparent from the following detailed description when taken in conjunction with the accompanying drawings.

### BRIEF DESCRIPTION OF THE DRAWINGS

FIG. 1 is a diagram of a power supply circuit according to a first embodiment of the present disclosure.

FIG. 2 shows waveform diagrams relating to the power supply circuit of FIG. 1.

FIG. 3 is an abbreviated diagram of a power supply circuit according to a second embodiment of the present disclosure.

FIG. 4 shows waveform diagrams relating to the power supply circuit of FIG. 3.

### DETAILED DESCRIPTION

Reference will now be made to the drawings to describe exemplary embodiments of the present disclosure in detail.

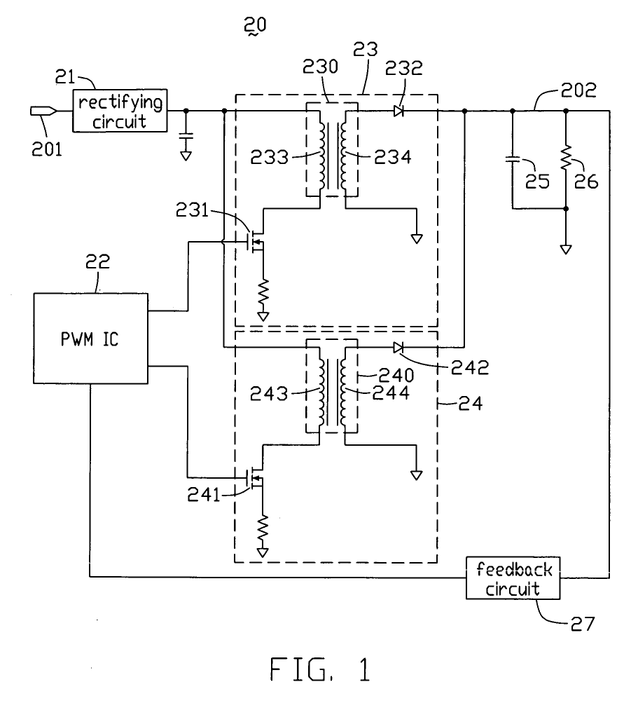

FIG. 1 is a diagram of a power supply circuit 20 according to a first embodiment of the present disclosure. The power supply circuit 20 provides electrical power to an electronic device, such as a liquid crystal display (LCD).

In one embodiment, the power supply circuit 20 includes an input terminal 201, a rectifying circuit 21, a pulse width modulation integrated circuit (PWM IC) 22, a first voltage converting circuit 23, a second voltage converting circuit 24, a filter capacitor 25, a load circuit 26, a feedback circuit 27, and an output terminal 202.

The rectifying circuit 21 can, for example, be a full-bridge rectifying circuit or a half-bridge rectifying circuit. The PWM IC 22 is configured to supply voltage control signals with different phases to the first voltage converting circuit 23 and the second voltage converting circuit 24, respectively. The first and second voltage converting circuits 23, 24 are controlled to output pulse voltages with different phases according to the voltage control signals. The feedback circuit 27 detects the output voltage of the output terminal 202, and feeds back a corresponding feedback signal to the PWM IC 22.

The first voltage converting circuit 23 includes a first transformer 230, a first transistor 231, and a first rectifying diode 232. The first transformer 230 includes a first primary winding 233 and a first secondary winding 234.

The second voltage converting circuit 24 includes a second transformer 240, a second transistor 241, and a second rectifying diode 242. The second transformer 240 includes a second primary winding 243 and a second secondary winding 244.

The input terminal 201 is respectively connected to first ends of the first and second primary windings 233, 243 via the rectifying circuit 21. A second end of the first primary winding 233 is connected to a drain electrode of the first transistor 231. A source electrode of the first transistor 231 is grounded via a resistor (not labeled). A gate electrode of the first transistor 231 is connected to the PWM IC 22. One end of the first secondary winding 234 is connected to the output terminal 202 via the positive electrode and negative electrode of the first rectifying diode 232 in series, and the other end of the first secondary winding 234 is grounded. A second end of the second primary winding 243 is connected to a drain electrode of the second transistor 241. A source electrode of the second transistor 241 is grounded via a resistor (not labeled). A gate electrode of the second transistor 241 is connected to the PWM IC 22. One end of the second secondary winding 234 is connected to the output terminal 202 via the positive electrode and negative electrode of the second rectifying diode 242, and the other end of the second secondary winding 234 is grounded. The filter capacitor 25 and the load circuit 26 are connected in parallel between the output terminal 202 and ground.

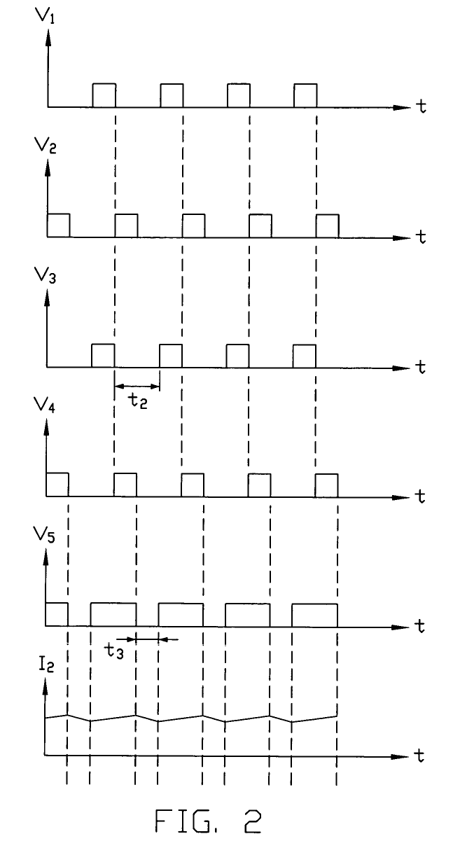

FIG. 2 shows waveforms of the power supply circuit 20. Axes V1, V2 represent voltages applied to the gate electrodes of the first and second transistors 231, 241 by the PWM IC 22, respectively. Axes V3, V4 represent voltages outputted from the first and second rectifying diodes 232, 242. Axis V5 represents a voltage between two electrodes of the rectifying capacitor 25. Axis 12 represents electric current outputted from the output terminal 202. In all the diagrams “t” represents time.

When an external AC voltage is applied to the input terminal 201, the AC voltage is rectified into a DC voltage by the rectifying circuit 21, and is then applied to the first and second primary windings 233, 243. The PWM IC 22 generates and outputs two voltage control signals V1, V2 to the gate electrodes of the first and second transistors 231, 241. A phase of the control signal V1 has a delay compared with that of the control signal V2, for example a delay of 120 degrees.

Under control of the control signal V1, the first transistor 231 is switched on and off alternately. The rectified DC voltage is applied to the first primary winding 233 when the first transistor 231 is switched on. Then the first secondary winding 234 generates an induction voltage, and transmits the induction voltage to the first rectifying diode 232. The first rectifying diode 232 rectifies the induction voltage, thereby forming a first pulse voltage V3. In each pulse time period, a low level period of the first pulse voltage V3 is t2. Similarly, under the control of the control signal V2, a second pulse voltage V4 is generated at the negative electrode of the second rectifying diode 242. Because the phase of the control signal V2 is delayed by a predetermined degree compared with that of the control signal V1, a phase of the second pulse voltage V4 has a same delay compared with that of the first pulse voltage V3. The delay can, for example, be 120 degrees.

The first and second pulse voltages V3, V4 are both applied to the filter capacitor 25 simultaneously. Because of the phase delay between the two pulse voltages V3, V4, the high level period of the second pulse voltage V4 overlaps the low level period of the first pulse voltage V3, and the high level period of the first pulse voltage V3 overlaps the low level period of the second pulse voltage V4. That is, the first and second pulse voltages V3, V4 complement each other. Thereby, a composed pulse voltage V5 is formed and applied to the filter capacitor 25. In the composed pulse voltage V5, the high level period is prolonged, and the low level period is shortened. In this embodiment, the low level period of the composed pulse voltage V5 is t3, and t3<t2. During the high level period, the output terminal 202 provides electrical power to the load circuit 26 and charges the filter capacitor 25, thereby storing electrical power in the filter capacitor 25. The longer the high level period is, the more the electrical power is stored in the filter capacitor 25. During the low level period t3, the filter capacitor 25 discharges and functions as a power supply to provide electrical power to the load circuit 26. As a result, the filter capacitor 25 outputs a DC current I2 to drive the load circuit 26.

In the above-described embodiment, the power supply 20 includes a first voltage converting circuit 23 and a second voltage converting circuit 24. The first and second voltage converting circuits 23, 24 are controlled by the PWM IC 22 to generate the first and second pulse voltages V3, V4. The phase of the second pulse voltage V4 is delayed by 120 degrees compared with that of the first pulse voltage V3. The first and second pulse voltages V3, V4 are both provided to the filter capacitor 25. The high level period of the second pulse voltage V4 compensates part of the low level period of the first pulse voltage V3. Thereby, the low level period of the composed pulse voltage V5 is shortened, and the high level period of the composed pulse voltage V5 is prolonged. As a result, a voltage fall of the output terminal 202 is reduced, thereby reducing a ripple of the output voltage of the output terminal 202. Thus the stability of the output of the power supply circuit 20 is improved.

Moreover, the filter capacitor 25 provides electrical power to the load circuit 26 only in the time period t3, which is relatively short, This is helpful to reduce an operating temperature of the filter capacitor 25 and prolong a working lifetime of the filter capacitor 25. Furthermore, the first and second voltage converting circuits 23, 24 define a push-pull output circuit. Thus the first and second transformers 230, 240 can work at relatively low frequencies. This reduces a magnetic loss and increases a power utilization of the power supply circuit 20.

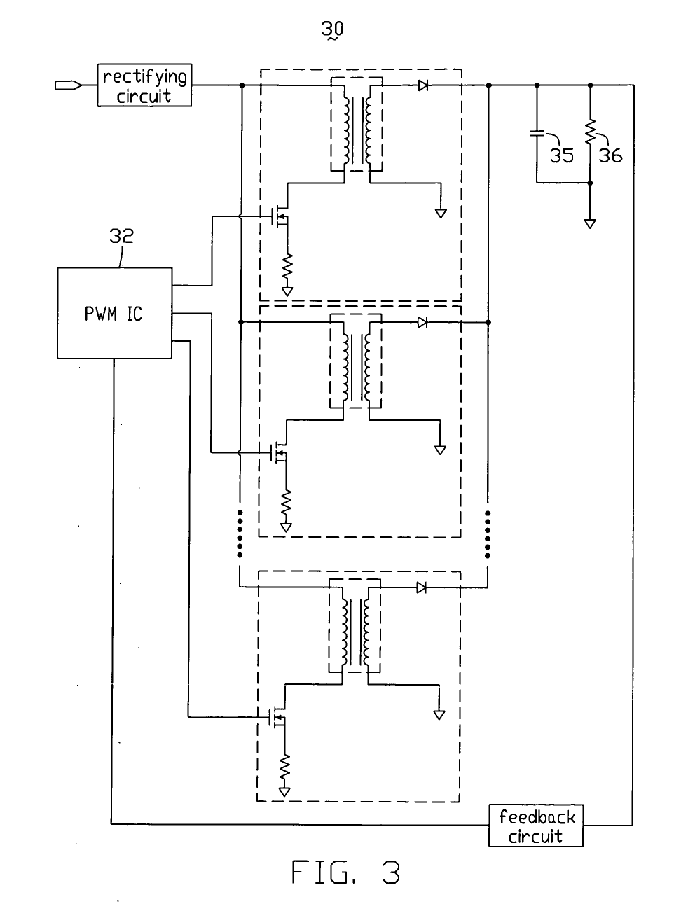

Referring to FIG. 3, this is a diagram of a power supply circuit 30 according to a second embodiment of the present disclosure. The power supply circuit 30 is similar to the power supply circuit 20. However, the power supply circuit 30 differs in that it includes a first, a second, etc . . . , through to an Nth voltage converting circuit (not labeled), wherein N is a natural number which is larger than 2.

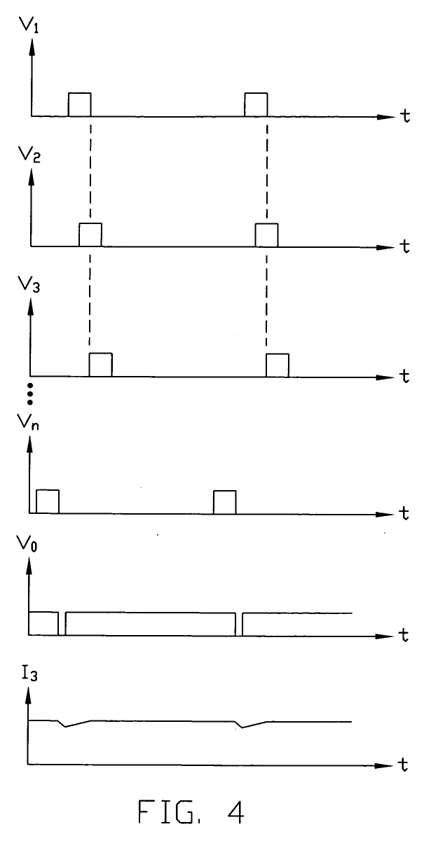

A PWM IC 32 is configured to provide N voltage control signals to control the N voltage converting circuits, respectively. In the N control signals, a phase of the Mth control signal is delayed by 360/(N+1) degrees relative to the (M−1)th voltage control signal, wherein 2≦M≦N. Also referring to FIG. 4, under control of the N voltage control signals, the N voltage converting circuits generate N pulse voltages V1˜Vn, respectively, and provide the N pulse voltages V1˜Vn to a filter capacitor 35. The N pulse voltages V1˜Vn complement each other, thereby forming a composed pulse voltage V0. The composed pulse voltage V0 is directly provided to a load circuit 36.

The composed pulse voltage V0 has a prolonged high level period and a shortened low level period. When the number N is large enough, the low level period of the composed pulse voltage V0 approaches zero, and the composed pulse voltage V0 approximates to or can be recognized as a constant DC voltage. Thus a capacitance of the filter capacitor 35 can be configured at a low level, or the filter capacitor 35 can even be omitted.

It is to be further understood that even though numerous characteristics and advantages of various embodiments have been set out in the foregoing description, together with details of structures and functions associated with the embodiments, the disclosure is illustrative only; and that changes may be made in detail (including in matters of arrangement of parts) within the principles of the disclosure to the full extent indicated by the broad general meaning of the terms in which the appended claims are expressed.

What is claimed is:

1. A power supply circuit, comprising:
an input terminal capable of receiving a direct current voltage;
an output terminal capable of providing voltage to a load circuit;
a plurality of voltage converting circuits connected in parallel between the input terminal and the output terminal; and
a pulse width modulation circuit;
wherein the pulse width modulation circuit is configured to control the plurality of voltage converting circuits to convert the direct current voltage into a plurality of pulse voltages, wherein a phase of each pulse voltage is delayed relative to that of an adjacent preceding pulse voltage.

2. The power supply circuit of claim 1, further comprising a rectifying circuit capable of receiving an alternating current voltage, and outputting a direct current voltage to the plurality of voltage converting circuits.

3. The power supply circuit of claim 1, further comprising a filter capacitor connected between the output terminal and ground.

4. The power supply circuit of claim 3, wherein each voltage converting circuit comprises a transformer with a primary winding and a secondary winding, a transistor, and a rectifying diode, one end of the primary winding is connected to the input terminal, the other end of the primary winding is connected to a drain electrode of the transistor, a source electrode of the transistor is grounded, one end of the secondary winding is grounded, and the other end of the secondary winding is connected to the output terminal via the rectifying diode.

5. The power supply circuit of claim 4, wherein each voltage converting circuit further comprises a resistor, and the source electrode of the transistor is grounded via the resistor.

6. The power supply circuit of claim 1, further comprising a feedback circuit configured for feeding a signal corresponding to an output voltage of the output terminal back to the pulse width modulation circuit.

7. The power supply circuit of claim 1, wherein the plurality of voltage converting circuits is two voltage converting circuits, and the phase delay between the two pulse voltages is 120 degrees.

8. A power supply circuit, comprising:
an input terminal capable of receiving external voltage;
an output terminal capable of providing voltage to a load;
N voltage converting circuits connected in parallel between the input terminal and the output terminal, wherein N is a natural number larger than one; and
a pulse width modulation circuit;
wherein the pulse width modulation circuit is configured to provide N voltage control signals to the voltage converting circuits, respectively, with a phase delay existing between each two adjacent voltage control signals, and the voltage converting circuits are configured to generate N pulse voltages according to the N voltage control signals.

9. The power supply circuit of claim 8, further comprising a rectifying circuit configured for receiving alternating current voltage, and outputting direct current voltage to the voltage converting circuits.

10. The power supply circuit of claim 8, further comprising a filter capacitor connected between the output terminal and ground.

11. The power supply circuit of claim 10, wherein each voltage converting circuit comprises a transformer with a primary winding and a secondary winding, a transistor, and a rectifying diode, one end of the primary winding is connected to the input terminal, the other end of the primary winding is connected to a drain electrode of the transistor, a source electrode of the transistor is grounded, one end of the secondary winding is grounded, and the other end of the secondary winding is connected to the output terminal via the rectifying diode.

12. The power supply circuit of claim 11, wherein each voltage converting circuit further comprises a resistor, and the source electrode of the transistor is grounded via the resistor.

13. The power supply circuit of claim 8, further comprising a feedback circuit configured for feeding a signal corresponding to an output voltage of the output terminal back to the pulse width modulation circuit.

14. The power supply circuit of claim 9, wherein the voltage converting circuits are configured to generate the pulse voltages with a phase delay existing between each two adjacent pulse voltages, the phase delay between each two adjacent pulse voltages corresponding to the phase delay between each two adjacent voltage control signals.

15. The power supply circuit of claim 14, wherein the phase delay between each two adjacent pulse voltages is 360/(N+1) degrees.

16. A control method for a power supply circuit, the method comprising:
generating N voltage control signals, N being a natural number larger than one, a phase delay existing between each two adjacent voltage control signals;
generating N pulse voltages by N voltage converting circuits according to the voltage control signals, a phase delay existing between each two adjacent pulse voltages; and
providing the pulse voltages to a load.

17. The control method of claim 16, wherein the phase delay between each two adjacent voltage control signals is 360/(N+1) degrees.

18. The control method of claim 16, wherein the phase delay between each two adjacent pulse voltages is 360/(N+1) degrees.
